(19) United States
(12) Patent Application Publication
(10) Pub. No.: US 2022/0364683 A1
(43) Pub. Date: Nov. 17, 2022

(54) CRYOGENIC STORAGE CONTAINER, CLOSING ELEMENT, AND METHOD OF MANUFACTURE

(71) Applicant: BioLife Solutions, Inc., Bothell, WA (US)

(72) Inventors: Bruce McCormick, Santa Fe, NM (US); Gordon Barnard, Albuquerque, NM (US)

(21) Appl. No.: 17/318,121

(22) Filed: May 12, 2021

(51) Int. Cl. F17C 13/06; F17C 13/00

(52) U.S. Cl. CPC F17C 13/06; F17C 13/001; F17C 2205/0311; F17C 2205/0338; F17C 2223/0161; F17C 2250/0491

(57) ABSTRACT

A closing element for selectively blocking an opening of a cryogenic storage container is disclosed. The closing element has a head assembly and a bottom member, at least one layer of insulating material disposed between the head assembly and the bottom member, at least one hole extending through the insulating material, and at least one member disposed in the at least one hole and extending through the insulating material. A diameter of the at least one hole is substantially equal to a diameter of the at least one member.

### BACKGROUND OF THE INVENTION

### Field of the Invention

The present disclosure generally relates to a transportation apparatus, system, and method, and more particularly to an apparatus, system, and method for transporting material.

### Description of Related Art

Shipping cryogenically frozen materials by air transportation typically involves the use of dry vapor shippers. A typical type of these shippers are vacuum dewars that utilize a fluid cooling, such as liquid nitrogen, disposed inside the dewars to maintain desired cryogenic temperatures. An absorbent material can be disposed inside the dewars to absorb and hold fluid coolant in liquid form.

A dry vapor shipper (DVS) typically allows access to its interior via an opening or access port, which can be closed by an insulated vapor plug. The vapor plug seals an otherwise large path for heat to enter the DVS, while also providing a defined pathway for the release of gas, which causes pressure buildup as liquid coolant phase changes to gas. Liquid nitrogen, for example, expands 698 times from its liquid volume when that liquid phase changes to a gas. The vapor plug seals at a neck of the DVS between the interior of the DVS and the exterior of the DVS. The sealed connection, however, if imperfect, creates a path for heat to enter the DVS, and for coolant to escape.

There are several challenges to the design of an efficient vapor plug for a DVS. A principal challenge is providing a thermal barrier between the outside environment and a payload area of the interior. The difference in temperature typically exceeds of 200 degrees Celsius. This temperature is often called the “boundary temperature,” which typically ranges from about 77 degrees Kelvin (liquid nitrogen) to about 293 degrees Kelvin (room temperature).

To measure a temperature of a payload in a DVS, the DVS is typically fitted with a thermal sensor or probe. Running a thermal sensor and corresponding wiring into a cryogenic temperature region of a DVS without incurring additional heat loss is technically challenging. Positioning a tip of the thermal sensor at a known location within the DVS and avoiding damage to the sensor tip and wire are further challenges in utilizing a thermal sensor within the DVS. When the sensor is in a cryogenic region and the sensor tip and the sensor element are at cryogenic temperatures, sensor elements can be rendered inflexible and can break.

The sensor wire represents a significant pathway for the introduction of heat into the DVS interior payload area, with this heat path including two principal forms or paths of heat transfer. The first pathway involves conduction of heat through the wire itself. The second pathway involves spatial gaps related to how the wire is introduced into the DVS from the exterior. One conventional technique of running this wire includes positioning the wire between the plug exterior and the neck wall of the DVS unit. Another conventional technique is to drill a hole through the vapor plug transiting the exterior to the interior to allow the sensor and/or sensor wire to be inserted into the hole. This method typically leads to a pathway for gas to easily pass from inside the DVS to the exterior. This spatial gap occurs when the hole is sized larger than the space occupied by the sensor wire. Such a circumstance can occur, for example, when the thermal sensor tip is of a larger diameter than the wire, and the hole is sized sufficiently large to accommodate the passage of the tip through the hole. After the tip has passed through the hole, the wire remaining in the hole is of a diameter that is smaller than the hole size, which results in a free path for gas to flow through the hole and causes undesired heat transfer.

Another challenge with DVS plug design involves providing a sufficient free flowing pathway for gas to vent to eliminate the potential for dangerous pressure accumulation in the interior of the DVS. Particularly, designing a pathway for sufficient coolant gas to vent from the interior of the DVS with minimal heat exchange creates a challenge for vapor plug design. A gas vent that allows a free flow of gas from the inside of the DVS to the exterior of the DVS also allows a free flow of heat from the exterior of the unit to the interior of the DVS. Any increase in venting capacity further increases the flow of heat from the exterior to the interior of the DVS, thereby resulting in a cascading decrease in thermal stability of the payload within a desired temperature range (thermal performance).

Another challenge with the DVS plug design involves inconsistent size due to both temperature variation and structural weakness. As the vapor plug is exposed to temperatures ranging between, for example, 77 degrees K to about 293 degrees K, at different times or simultaneously, the vapor plug expands and contracts, bending the vapor plug out of shape such that the plug fits less snugly into the access port than desired. This size inconsistency of the vapor plug creates further pathways for heat convection and/or conduction.

A further challenge involves the orientation of the DVS and the weight of the coolant gas. When a DVS is in an upright orientation, the coolant gas sinks to the bottom of the DVS, while relatively warmer gas occupies the space immediately surrounding the vapor plug. Accordingly, when the DVS is oriented upright, the temperature differential between the area immediately outside the DVS at the vapor plug and immediately inside the DVS at the vapor plug is relatively low, and positioning the DVS in an upright orientation yields a relatively low heat flow through the vapor plug. The temperature differential increases, however, when the orientation of the DVS changes. For example, when the DVS is turned on its side or turned upside down, the coolant gas presses up against the vapor plug, which results in a larger temperature differential between the outside of the vapor plug and the inside. This greater temperature differential results in a greater heat flow through the vapor plug, which reduces the thermal performance of the DVS. Further, as the heat flow increases in the DVS, vaporization of the nitrogen gas also increases, thereby decreasing longevity and efficiency of the coolant. As a result of the dramatic difference in thermal performance due to orientation of the DVS, shippers either go to great efforts to ensure the DVS units are shipped upright, which can be burdensome, or the shippers will avoid long use of the units. This issue, coupled with lack of visibility in actual DVS orientation during shipments, leads to poor ability to reliably calculate estimated thermal performance of a DVS used in an actual shipment. The disclosed apparatus, system, and method of the present disclosure are directed to overcoming one or more of the shortcomings set forth above and/or other deficiencies in existing technology.

### SUMMARY OF THE INVENTION

In an embodiment, a closing element for selectively blocking an opening of a cryogenic storage container includes a head assembly, a bottom member, at least one layer of insulating material disposed between the head assembly and the bottom member, at least one hole extending through the at least one layer of insulating material, and at least one member disposed in the at least one hole and extending through the insulating material, wherein a diameter of the at least one hole is substantially equal to a diameter of the at least one member.

In another embodiment, a method of manufacturing a closing element to block an opening of a cryogenic storage container includes providing at least one layer of insulating material, providing at least one hole extending through at least one layer of the insulating material, providing at least one member in the at least one hole, inserting an end portion of the at least one member in a fastening component, and compressing the at least one layer of insulating material by moving the fastening component relative to the at least one member.

In another embodiment, a cryogenic storage container includes a housing and a closing element. The housing includes a cavity and a neck opening. The closing element is configured to be selectively inserted in the neck opening. The closing element includes a head assembly and a bottom member, at least one layer of insulating material disposed between the head assembly and the bottom member, at least one hole extending through the at least one layer of insulating material, and at least one member disposed in the at least one hole and extending through the at least one layer of insulating material. A diameter of the at least one hole is substantially equal to a diameter of the at least one member.

### BRIEF DESCRIPTION OF THE DRAWING

FIG. 1 is a side view of an apparatus in an open position, according to an embodiment of the invention;

FIG. 1A is a partial side view of the apparatus of FIG. 1 in a closed position;

FIG. 2 is a perspective view of a closing element, according to an embodiment of the invention;

FIG. 3 is a sectional view of the closing element of FIG. 2 (section A-A of FIG. 2);

FIG. 4 is a sectional view of the closing element of FIG. 2 (section B-B of FIG. 2);

FIG. 5A is a perspective view of components of a closing element, according to an embodiment of the invention;

FIG. 5B is a perspective view of components of a closing element, according to an embodiment of the invention;

FIG. 6 is a perspective view of components of a closing element, according to an embodiment of the invention;

FIG. 7 is a perspective view of the closing element, according to an embodiment of the invention;

FIG. 8 is a perspective view of the closing element, according to an embodiment of the invention;

FIG. 9 illustrates a process of according to an embodiment of the invention;

FIG. 10 illustrates a process of fabricating a closing element, according to an embodiment of the invention;

FIG. 11 is a perspective view of a closing element at a stage during fabrication, according to an embodiment of the invention;

FIG. 12 is a perspective view of a closing element at a stage during fabrication, according to an embodiment of the invention;

FIG. 13 is a perspective view of components of a closing element at a stage during fabrication, according to an embodiment of the invention.

FIG. 14 is a schematic illustration of a computing device, in accordance with at least some embodiments of the invention; and

FIG. 15 is a schematic illustration of a network, in accordance with at least some embodiments of the invention.

### DETAILED DESCRIPTION OF THE INVENTION

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless specified otherwise, the terms “substantially”, “about”, or “approximately” can mean any value within a range from the specified value, wherein the range can be any range with a first inclusive end value of 0% and a second inclusive end value between 0% and +/−10%, inclusively.

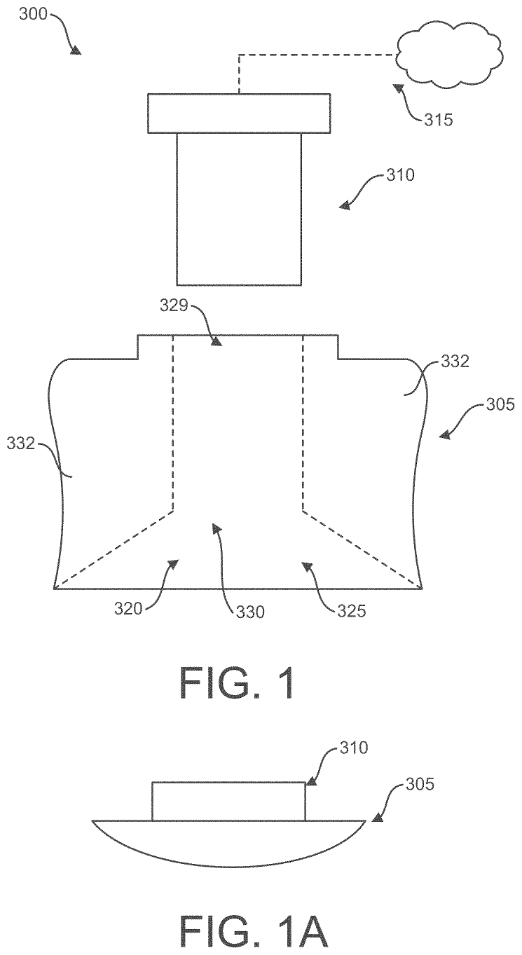

FIG. 1 illustrates an apparatus 300 for storing or transporting material at temperatures below ambient, such as at cryogenic temperatures. Apparatus 300 includes a container 305, a closing element 310, and a data system 315. Closing element 310 can selectively block an opening of container 305. Data system 315 can be used to process data collected by one or more sensors of closing element 310 (e.g., and/or container 305). Container 305 can be a portable container or dewar. For example, container 305 can be a dry vapor shipper. Container 305 can include a cavity 325, in which a fluid coolant 320 can be positioned. Container 305 can be configured for storing or transporting material cooled by the fluid coolant 320, such as a cryogenic fluid like liquid nitrogen. Fluid coolant 320 can have a boiling point that is less than or equal to −150 degrees Celsius. Fluid coolant 320 can be cryogenic fluid or cryogen that can be in liquid and/or gaseous form. In at least some embodiments, fluid coolant 320 can include nitrogen, helium, hydrogen, neon, oxygen, and/or air. For example, fluid coolant 320 can be nitrogen that is used as a refrigerant to maintain desired cryogenic temperatures (e.g., between about −196 degrees Celsius (about 77 degrees Kelvin) and about −150 degrees Celsius (about 123 degrees Kelvin)).

Closing element 310 can be configured to selectively block an access port, opening or aperture, such as access port 329 at neck 330 of container 305. The access port 329 is formed by one or more wall portions 332 of container 305. Closing element 310 can be disposed in an uninstalled position relative to container 305 as illustrated in FIG. 1, or disposed in an installed position (e.g., working position) relative to container 305 as illustrated in FIG. 1A, in which closing element 310 can seal the access port 329 of neck 330. Fluid coolant 320 can thereby be selectively sealed in cavity 325 by closing element 310 when closing element 310 is disposed in the installed position as illustrated in FIG. 1A.

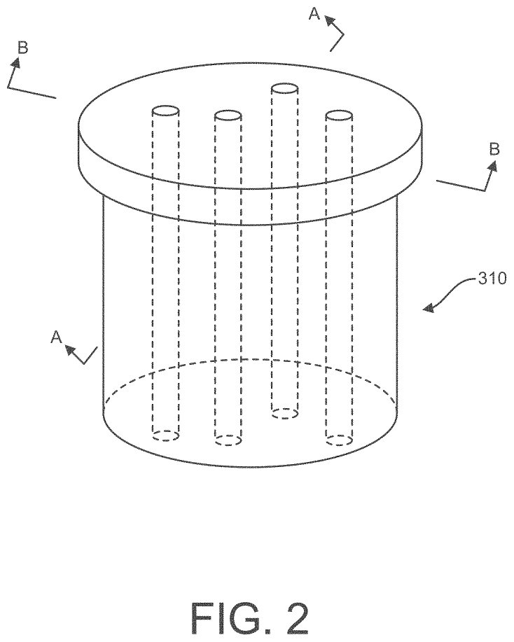

FIGS. 2-4 illustrate closing element 310. Closing element 310 includes a housing assembly 345 internally supporting an insulating material 348. The insulating material can be one with properties suitable for reducing or minimizing thermal conduction through the closing element 310. For example, insulating material 348 can be super insulating material having a relatively very low thermal conductivity, such as a thermal conductivity less than 0.02 W/m-K. In at least some embodiments, insulating material 348 can include aerogel material such as aerogel blanket material. Insulating material 348 can include microporous material. In at least some embodiments, insulating material 348 can include a plurality of layers. In at least some embodiments, insulating material 348 can be incompressible or substantially incompressible. In some embodiments, one or more layers of insulating material 348 can have low compressibility and/or low elasticity.

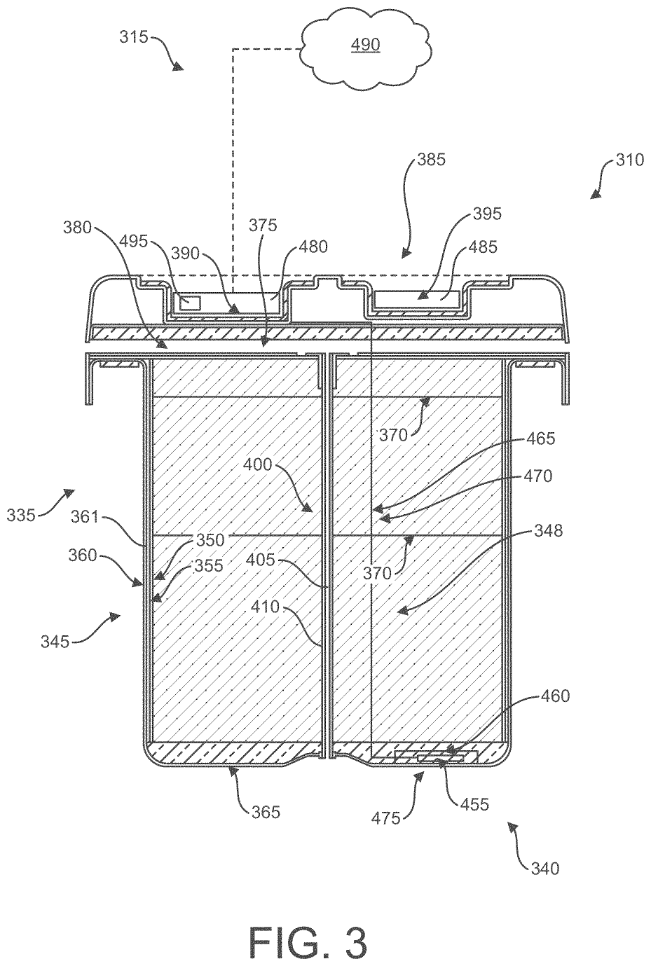

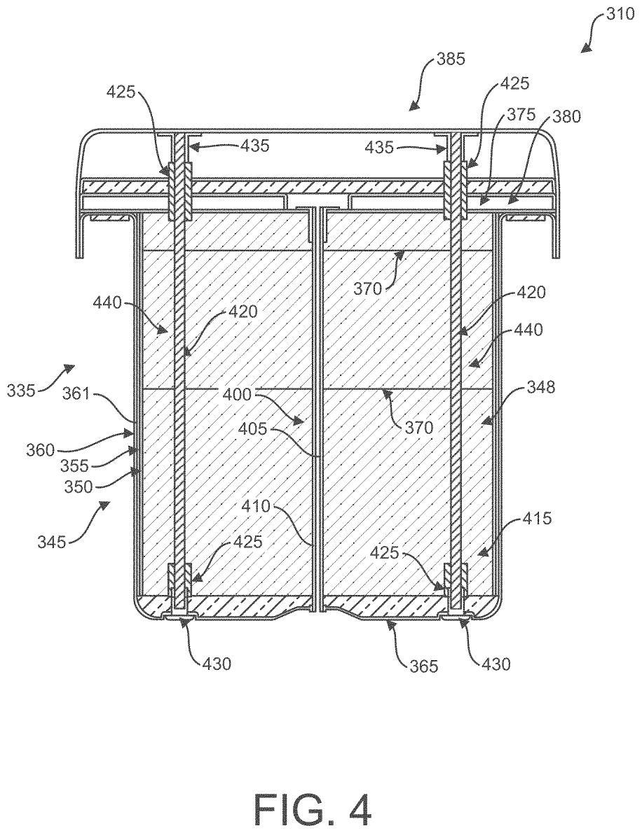

As illustrated in FIGS. 3 and 4, a reflecting material 370 can be disposed in insulating material 348. Reflecting material 370 can be a foil material. For example, reflecting material 370 can include metal foils and/or metalized foils. Two layers of reflecting material 370 are illustrated in FIGS. 3 and 4, though reflecting material 370 can include a single layer or other numbers of layers disposed between layers of insulating material 348. For example, a plurality of layers of reflecting material 370 can be separated from one another between layers of insulating material 348. Reflecting material 370 can be oriented substantially perpendicularly to a direction of heat flow through closing element 310 from an interior (e.g., cavity 325) of container 305 to an exterior of container 305. For example, the reflecting material 370 is shown oriented in this direction in FIGS. 3 and 4.

Still referring to FIGS. 3 and 4, closing element 310 includes an outer layer, which includes one or more of a first layer 350, a second layer 355, a third layer 360, and a fourth layer 361. Layers 350, 355, 360 can form an outer layer that can be attached to member 365, thereby forming housing assembly 345, which can contain insulating material 348. Any combination of the layers 350, 355, and 360 can be omitted or utilized in the general manner described with reference to FIG. 3. As illustrated in FIG. 3, first layer 350 can be disposed over and/or around insulating material 348. First layer 350 can be disposed between insulating material 348 and layer 355. First layer 350 can be a heat shrink tubing. First layer 350 can be affixed to insulating material 348, for example, by heating first layer 350, which can effectively lock insulating material 348 into a fixed position and can facilitate structural rigidity. First layer 350 can seal insulating material 348. First layer 350 can be wrapped around insulating material 348 one or more times. First layer 350 can serve to encapsulate (e.g., hermetically seal) substantially all potential dust material or debris from insulating material 348 to reduce or substantially prevent harm to users and/or reduce or substantially prevent potential contamination of a product payload. First layer 350 can serve as an adhesive substrate. For example, first layer 350 can include or be used with a glue substrate for adhering additional materials (e.g., second layer 355 and/or third layer 360) to first layer 350 during manufacturing of closing element 310.

First layer 350 can be any suitable structural material for application around insulating material 348. First layer 350 can be a substantially linear polymer material (e.g., polyethylene). First layer 350 can be any suitable low-density polyethylene (LDPE) material. For example, first layer 350 can be a linear low-density polyethylene film (LLDP) or any other suitable similar material.

Second layer 355 can be disposed between first layer 350 and third layer 360. Second layer 355 can be any suitable structural material for surrounding and/or being disposed around first layer 350. Second layer 355 can be a high-density polyethylene material. Second layer 355 can be in rolled form, such as a non-woven high-density polyethylene fiber material (e.g., in rolled form). Second layer 355 can be wrapped multiple times around first layer 350. Second layer 355 can be adhered to layer 350 after being wrapped around first layer 350 by using adhesive (e.g., liquid adhesive, spray adhesive, and/or adhesive back tape). Second layer 355 can be a nonwoven material including spun bond olefin fiber. Second layer 355 can be a flash spun high-density polyethylene fiber material. In at least some embodiments, second layer 355 can be Tyvek® material available from DuPont. Second layer 355 can be conformable, facilitating conformation of closing element 310 inside neck 330 of container 305, and can provide structural rigidity to first layer 350 and insulating material 348. Layers 350 and/or 355 can seal insulating material 348 to substantially prevent debris or dust from escaping or separating from insulating material 348.

Third layer 360 can be any suitable structural material for surrounding and/or being disposed around second layer 355. Third layer 360 can be disposed between second layer 355 and one or more wall portions 332 of container 305 when closing element 310 is in the installed position, or between second layer 355 and an environment external to closing element 310 when the closing element 310 is uninstalled to close the access port 329 of container 305. Third layer 360 can be a foam material. For example, third layer 360 can be a microcellular foam material. Third layer 360 can be a urethane foam material (e.g., polyurethane foam material). In at least some embodiments, third layer 360 can be Poron® material available from the Rogers corporation. The qualities of Poron® facilitate providing a relatively sanitary and durable exterior surface. Third layer 360 can be formed from any suitable material having suitable thermal and sealing properties to provide a seal (e.g., act as a sealing surface) against wall portions 332. Third layer 360 can be any suitable compressible material for filling an irregular shape of neck 330 (e.g., of wall portions 332). Poron®, for example, is conformable at ambient temperatures, but becomes nonconformable and structurally rigid as it gets cold. When closing element 310 is inserted into neck 330 of a container 305 containing cryogen, Poron initially conforms to the shape of neck 330, but quickly gets cold and stiffens. In at least some embodiments, layer 360 can have a thickness between about 0.5 mm and about 5 mm. Third layer 360 can be applied to second layer 355 using any suitable adhesive. For example, third layer 360 can be applied on second layer 355 as a singular layer of material with a beginning edge and an ending edge of material of third layer 360 butting together to define a closure of an outside perimeter of closing element 310. An exterior surface of third layer 360 can form an outside perimeter (e.g., outside perimeter dimension) of closing element 310 that can be configured (e.g., manufactured or constructed) within suitable dimensional tolerances to fit a given neck 330 of a given container 305 with which closing element 310 is to be used.

In some embodiments, the outer layer of housing assembly 345 can include a fourth layer 361 including fleece material (e.g., polyester fleece material) or any other material having suitable thermal properties and malleability at low temperatures that can be disposed on second layer 355 as the very outermost layer of the closing element 310, or disposed between third layer 360 and second layer 355. Also, for example, the fleece material can provide a non-absorbent surface, which can provide a sanitary benefit to closing element 310. Fleece retains a high degree of its conformability and softness over a wide range of temperatures, facilitating good conformation of the closing element 310 in the neck 330 of the container 330 at ambient or cryogenic temperatures.

In at least some embodiments, the layers 350, 355, and/or 360 can be layers of pliable insulation, which can allow closing element 310 to conform to non-uniform or out-of-round DVS necks (e.g., neck 330) when placed in the installed position. The laminated materials (e.g., layers 350, 355, and/or 355) can remain pliable over a working range of temperatures that closing element 310 experiences during an operation of apparatus 300.

Member 365 can be formed from any materials having suitably low thermal conductivity and suitable structural characteristics for forming a bottom cap of closing element 310. Member 365 can be formed from material similar to layers 350, 355, and/or 360. In at least some embodiments, member 365 can include a thermoplastic material. For example, member 365 can be a multi-layer thermoplastic having foam material disposed between layers of thermoplastic foam (e.g., non-foam thermoplastic material). Member 365 can include polyester-based copolymer material, thermoplastic elastomer material, and/or thermoplastic olefin material.

Still referring to FIGS. 3 and 4, closing element 310 can include a heat exchanger 375 that can be disposed in a cavity 380 of assembly 335, for example as illustrated in FIG. 4. Cavity 380 can be for example a heat sink channel to which heat exchanger 375 can be adjacent and/or in which heat exchanger 375 can be disposed. Heat exchanger 375 can be a passive heat exchanger. Heat exchanger 375 can be any suitable heat sink. For example, heat exchanger 375 can include a layer of relatively highly thermal conductive material such as copper, aluminum, and/or any other suitable material. In at least some embodiments, heat exchanger 375 can have a relatively large surface area-to-thickness ratio (e.g., equal to or greater than about 25,000 mm2/mm).

Closing element 310 can also include a head assembly 385. Head assembly 385 can form for example a cap (e.g., an outer cap) or head assembly of closing element 310. Head assembly 385 can be for example formed from materials similar to other components of assembly 335 and/or any other suitable structural material (e.g., structural materials having relatively low thermal conductivity). Head assembly 385 can be attached (e.g., fixedly or removably attached for example by fasteners, adhesive, welding, and/or any other suitable method) to other components of closing element 310 for example as illustrated in FIGS. 3 and 4. For example, head assembly 385 can be attached to other components of closing element 310 via the disclosed fastening assembly described below. As illustrated in FIG. 3, head assembly 385 can include a cavity 390 and a cavity 395 that can be formed by one or more wall members of head assembly 385. Cavity 390 and cavity 395 can be configured to house elements of sensor system 340, for example, as described below. In at least some embodiments, head assembly 385 can be disassembled into sub-assemblies to make repairs easier.

Closing element 310 can further include a vent assembly 400 as illustrated in FIGS. 3 and 4. Vent assembly 400 can, for example, serve as a fluid or gas vent of closing element 310. Vent assembly 400 can form a fluid passage 405 that can allow a portion of fluid coolant 320 (e.g., evaporated cryogen) to escape from cavity 325 of container 305. Vent assembly 400 can include a vent member 410 including a cavity (e.g., an elongated cavity) that forms fluid passage 405. Fluid passage 405 can be formed directly in the insulating material 348 without inclusion of vent member 410, though vent member provides a more durable and consistent fluid passage 405. Vent member 410 can be a tube that extends through insulating material 348. Vent member 410 can be formed from material similar to other components of closing element 310 such as, for example, any suitable structural material for carrying a flow of a portion of fluid coolant 320 (e.g., evaporated cryogen). Vent member 410 can be configured (e.g., have any suitable defined dimensions) to allow a portion of fluid coolant 320 (e.g., internal vaporized gas) to freely vent to an exterior of container 305 and closing element 310. In at least some embodiments, vent assembly 400 can provide a passageway between cavity 325 and an exterior of container 305 including when closing element 310 is disposed in the installed position to allow for a portion of fluid coolant 320 (e.g., nitrogen gas) to escape from apparatus 300. Vent member 410 can be sized to allow a portion of fluid coolant 320 (e.g., gas) to vent to substantially prevent an unsuitable accumulation of gas pressure on wall portions of container 305 forming cavity 325. For example, vent member 410 can be sized to substantially prevent a pressure within cavity 325 from exceeding about 25 PSI (pounds per square inch) on one or more surfaces of container 305 forming cavity 325. In at least some embodiments, vent member 410 can be sized to substantially prevent a pressure within cavity 325 from exceeding about 7.25 PSI on one or more surfaces of container 305 forming cavity 325.

A sizing of vent member 410 and fluid passage 405 can be based on determining a desired gas flow or gas flow range through vent member 410 based on an NVR (Nitrogen Vaporization Rate) of apparatus 300. For example, an effective insulation performance of apparatus 300 can be determined by measuring the NVR of apparatus 300 when the container 305 is fully charged, closing element 310 is in the installed position, and container 305 is placed on its side (e.g., whereby fluid coolant 320 such as nitrogen gas presses against closing element 310 to attempt to “spill out” of container 305). Closing element 310 can be configured to allow for desired insulation (e.g., maximal insulation) from heat transfer due to conduction, convection, and/or radiant heat transfer. The apparatus 300 when container 305 is disposed on its side can be considered to be at a “dynamic” position. The flow rate of fluid coolant 320 (e.g., a gas) through vent member 410 can be calculated based on a maximum internal pressure (e.g., 25 PSI, up to 25 PSI, or about 7.25 PSI) and an external pressure outside of container 305 equal to about standard sea level pressure (e.g., 14.7 PSI). Vent member 410 can be configured or sized (e.g., an inner diameter or cross-section can be sized) to allow for a suitable flow of a portion of fluid coolant 320 (e.g., a sufficient gas volume to flow) that is equal or greater than the NVR rate of apparatus 300 determined when container 305 is in the dynamic position. In at least some embodiments, an overall thermal performance (e.g., NVR) of container 305 when in the dynamic position can be less than 60 g/hr.

Closing element 310 can also include a fastening assembly 415 for example as illustrated in FIG. 4. Fastening assembly 415 can include one or more members 420, one or more fastening components 425, one or more first fasteners 430, and one or more second fasteners 435. Fastening component 425, first fastener 430, and second fastener 435 can attach or fasten member 420 as part of plug 310.

Member 420 can be an elongated structural member (e.g., a rod). Member 420 can be formed from thermosetting resin or plastic material. For example, member 420 can be formed from phenolic material. Member 420 can be a rod formed from phenolic material. As illustrated in FIG. 4, each member 420 can be disposed in a hole 440. For example, member 420 can pass through (e.g., transit) one or more layers of insulating material 348 via hole 440 that can be a defined hole in insulating material 348. Hole 440 can be configured (e.g., sized) to receive member 420. For example, hole 440 and member 420 can have substantially equal diameters and/or cross-sections that can be substantially constant diameters and/or cross-sections. “Substantially” in the phrase “substantially equal diameters” here means a trivial amount corresponding to the difference between diameters of two mating circular surfaces. Member 420 can be configured or sized to be received in hole 440 to eliminate a free path of fluid flow from cavity 325 of container 305 through hole 440 (e.g., member 420 disposed in hole 440 can substantially block a flow of gas). For example, the diameter of hole 440 can be smaller than the diameter of member 420 when member 420 is not in hole 440, and hole 440 can be elastically deformable to stretch, receive, and compress around member 420.

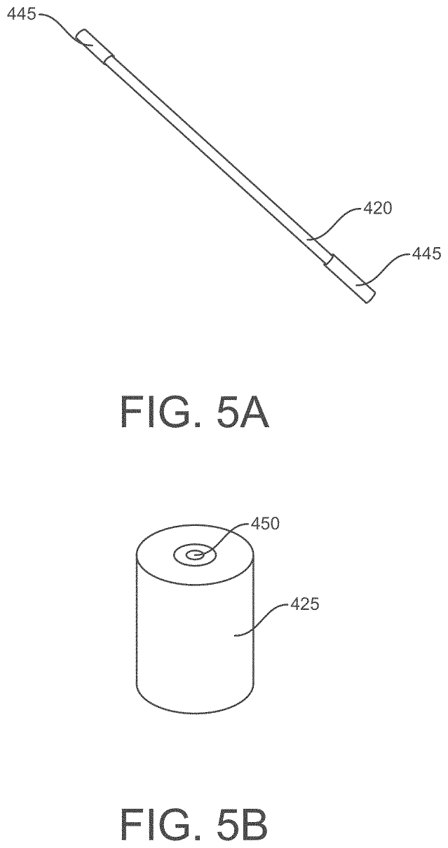

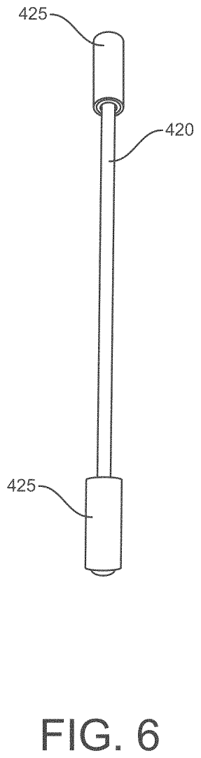

Each member 420 can be affixed to an underside of head assembly 385 by third fastener 435 and also to an inside of member 365 by fourth fastener 430. Fasteners 430, 435 can be any suitable mechanical fasteners that can fasten components by any suitable technique such as, for example, threading, adhering, welding, and/or any other suitable fastening technique. Each member 420 can be disposed in a given hole 440 and fastened between head assembly 385 and member 365 via fasteners 435, 430, respectively, for example as illustrated in FIG. 4. As illustrated in FIG. 5A, member 420 can include an end portion 445 at one or both ends that can be received in fastening component 425. End portion 445 can be a threaded portion that is threadably received in fastening component 425. Returning to FIG. 4, fastening component 425 can be formed from laminate material. Fastening component 425 can be a composite material including cured epoxy and fiberglass (e.g., a fiberglass-epoxy laminate). For example, fastening component 425 can be formed from phenolic material. Fastening component 425 can be a high-pressure fiberglass laminate or a thermoset glass-reinforced laminate. Fastening component 425 can include glass-woven fabric material. In at least some embodiments, fastening component 425 can be formed from Garolite (e.g., G-10 laminate material). Fastening component can also be formed from wood or wooden material or any other suitable material. As illustrated in FIG. 4, fastening components 425 can be disposed at an end portion of member 420 at member 365 and/or an end portion of member 420 at head assembly 385. Fastening component 425 can provide or act as a flange that can be fastened to member 420 to maintain compression on insulating material 348. As illustrated in FIG. 5B, fastening component 425 can include an insert 450 that can receive end portion 445 of member 420. Insert 450 can be a threaded insert that can receive end portion 445 of member 420 that can be threaded. Fastening component 425 can be used to provide a flange that maintains compression on insulating material 348 to substantially prevent separation of insulating material 348, and can also act as a housing for insert 450. In at least some embodiments, fastener component 425 can thereby allow member 420 to be fastened with threaded fasteners (e.g., fastener component 425) to secure members 420 to member 365 and head assembly 385 (e.g., thereby providing a secure monolithic shape of defined dimensions of insulating material 348). For example, fastening components 425 each having insert 450 can receive end portions 445 of member 420, for example, as illustrated in FIG. 6.

Returning to FIG. 4, fastening components 425 having inserts 450 can allow member 420 to be secured between head assembly 385 and member 365. Inserts 450 can receive and thereby be operably connected to respective end portions 445 of member 420 to allow fastening components 425 to compress insulating material 348. For example, inserts 450 that can be threadable inserts can threadably receive respective end portions 445 of member 420 to allow end portions 445 to be threaded into inserts 450 of respective fastening components 425 to compress insulating material 348 disposed between head assembly 385 and member 365. Members 420 can alternatively be press fit into inserts 450 and/or fastening components 425. Members 420 can alternatively be fastened to inserts 450 and/or fastening components 425 by any now-known or future-developed method. Members 420 can be thereby secured to head assembly 385 and member 365 to press together and secure insulating material 348 (e.g., layers of insulating material 348) to provide a monolithic shape or volume of insulating material 348 (e.g., of defined dimensions), for example, to prevent separation of insulating material 348. For example, members 420 can operate to make insulating material 348 into a monolith of desired, defined dimensions.

Sensor system 340 can include a sensor 455, a sensor housing 460, and a communication path element 465. For example, as illustrated in FIG. 3, sensor 455 can be disposed in sensor housing 460 and can be connected to components of data system 315 via communication path element 465, such as a wire. In some embodiments, the communication path element 465 can be omitted, and the sensor 455 can function through now-known or future-developed wireless means.

Sensor 455 can be any suitable sensor for monitoring a temperature of cavity 325 (e.g., of fluid coolant 320 disposed in cavity 325). Sensor 455 can be for example a probe such as a thermal probe. Sensor 455 can continuously sense temperature and provide data to data system 315 in real-time or near real-time or at any desired time intervals (e.g., intermittent sensing). Sensor 455 can be any suitable temperature sensor for use in sensing cryogenic temperatures. For example, sensor 455 can be a thermocouple sensor, a thermistor such as a negative temperature coefficient thermistor, a semiconductor-based integrated circuit, or a resistance temperature detector. Communication path element 465 can include any suitable electrical component(s) for electrically connecting sensor 455 to components of data system 315. For example, communication path element 465 can include an electrical wire or cable.

Sensor 455 can be inserted through insulating material 348 during an assembly of closing element 310. Sensor 455 can be inserted through a hole 470 of insulating material 348. For example, hole 470 can include aligned holes of each of a plurality of layers of insulating material 348. Hole 470 can be, for example, provided (e.g., cut) in insulating material 348. A diameter of hole 470 provided in insulating material 348 (e.g., or a diameter of aligned holes provided in a plurality of layers of insulating material 348) can be sized to correspond to a smallest diameter to accommodate passing or inserting sensor 455 through hole 470 (e.g., from an upper portion of insulating material 348 to a lower portion of insulating material 348 at which for example sensor housing 460 is disposed as illustrated in FIG. 3). Hole 470 can be for example a probe chase for installing sensor 455. Material such as material similar to insulating material 348 or any other suitable insulating material can be added to hole 470 after sensor 455 and communication path element 465 have been disposed in hole 470. For example, insulating material can be added to a top and bottom of hole 470 (e.g., and/or a central portion or substantially entirely along hole 470) to substantially block or reduce gas flow through hole 470. Disposing this disclosed material in hole 470 after installation of sensor 455 and communication path element 465 can reduce or substantially eliminate a free path for a portion of fluid coolant 320 (e.g., gas) to pass around communication path element 465 disposed in hole 470. Alternatively, hole 470 can be elastically deformable, and sized appropriately, to stretch, receive, and pass sensor housing 460, then compress around communication path element 465. In this case, when sensor 455 is pushed through hole 470, then hole 470 stretches to accommodate sensor housing 460, and compresses around communication path element 465. In this manner, the hole 470 seals around the communication path element 465. In an example, hole 470 can be 1 mm in diameter, sensor housing 460 can be 3 mm in diameter, and hole 470 can stretch to accept sensor housing 460 and compress and/or seal around communication path element 465. The resulting hole 470 has a diameter (or other appropriate dimension if communication path element 465 is not round) substantially equal to a diameter (or other appropriate dimension) of communication path element 465. “Substantially” in the phrase “substantially equal” here means a trivial amount corresponding to the difference in dimension between two mating surfaces.

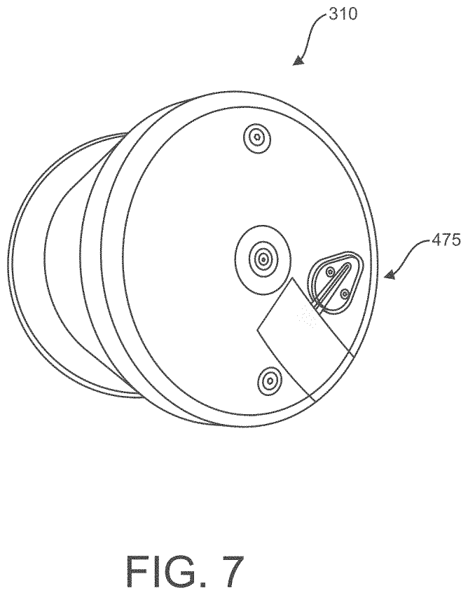

Sensor 455 can be disposed in sensor housing 460. Sensor housing 460 can be formed from any suitable structural material such as, for example, material similar to structural material of components of closure 310 (e.g., member 365) for example as described herein. Sensor housing 460 can for example form a cavity or pocket in member 365 for receiving sensor 455. Sensor housing 460 can for example be a housing disposed in member 365 and/or an integral portion of member 365 configured to receive sensor 455. Sensor 455 can be positioned in such a way as to reliably read internal temperature of container 305 and transmit data of this reading, for example, as described herein. Sensor housing 460 can be configured to receive or hold sensor 455 in a substantially fixed position at a bottom portion of closing element 310. For example, sensor housing 460 can substantially prevent sensor 455 from moving into (e.g., dangling in) cavity 325. Sensor housing 460 can be configured to expose a tip portion 475 at a bottom surface of closing element 310, for example, as illustrated in FIG. 7. Tip portion 475 can be a sensor tip that is exposed to cavity 325 when closing element 310 is in the disclosed installed position to measure (e.g., accurately measure) a temperature of cavity 325 (e.g., of fluid coolant 320 disposed in cavity 325). Sensor housing 460 can be configured to provide physical protection to sensor 455 (e.g., to tip portion 475) and/or communication path element 465 by reducing or substantially eliminating substantially any movement of sensor 455 and/or communication path element 465 based on maintaining sensor 455 in the substantially fixed position. Sensor 455 and communication path element 465 can be removable and/or replaceable from and in sensor housing 460 and hole 470.

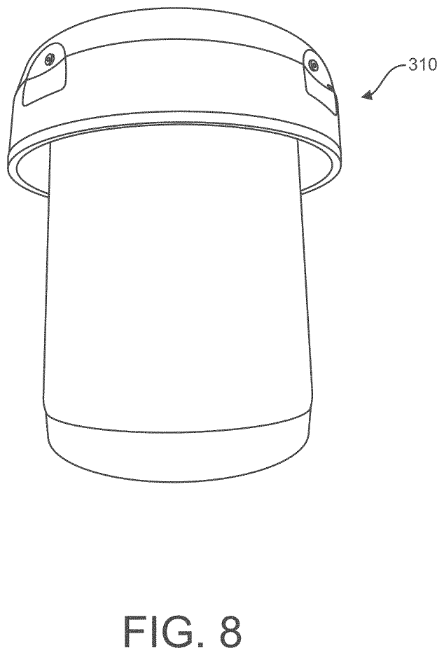

FIG. 8 illustrates an perspective view of closing element 310. In at least some embodiments, closing element 310 can be a “vapor plug” used for providing a vented insulated closure that can be used with container 305. In at least some embodiments, closing element 310 can be constructed of super insulating materials and can be formed from structural materials having a low thermal conductivity and being configured to have a dimensional size that can achieve relatively low effective thermal conductivity when assembled into a final form. Closing element 310 can also be constructed from materials that exhibit properties of relatively low (e.g., minimal contraction) when exposed to cryogenic temperatures, allowing for closing element 310 to maintain desired (e.g., strict) dimensional tolerances under a range of temperatures that closing element 310 can experience (e.g., temperatures of between about 77K and about 293K). Dimensional tolerances of an overall exterior of closing element 310 can not exceed a 1 mm difference between the disclosed temperature extremes that closing element 310 can experience.

Returning to FIG. 3, data system 315 may include a controller 480, a power source 485, and one or more network components 490. Controller 480 may be powered by power source 485 and may communicate with network components 490 and components of closing element 310, for example, as described below.

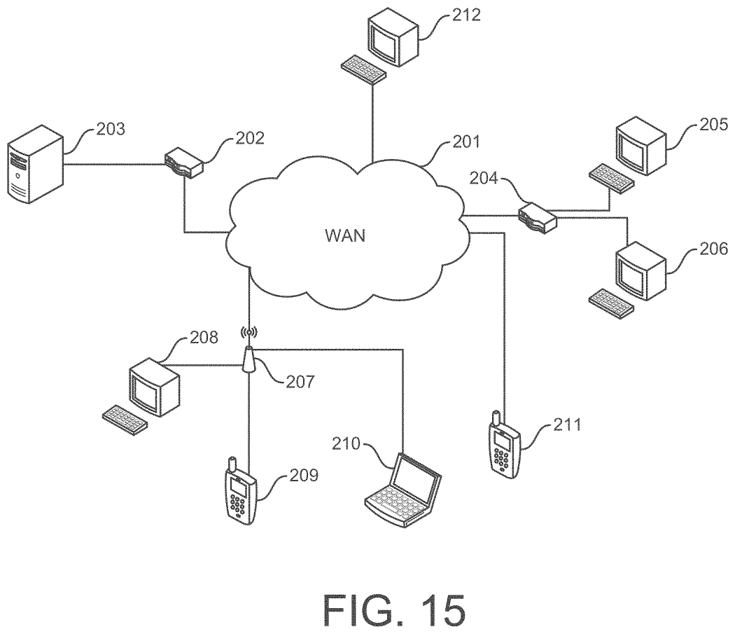

One or more network components 490 may include a WAN such as, for example, described below regarding FIG. 15. One or more network components 490 may also include user devices such as computing devices, smart devices such as smartphones, and any other suitable computing devices that may communicate with controller 480 via any suitable communication technique such as, for example, the techniques described herein. For example, the disclosed one or more user devices may include a touchscreen device (e.g., a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of system 300, and/or any other suitable user device or interface. One or more network components 490 and controller 480 may communicate with each other and/or any other suitable component of system 300 via any suitable communication method such as, for example, wireless communication (e.g., CDMA, GSM, 3G, 4G, and/or 5G), direct communication (e.g., wire communication), Bluetooth communication coverage, Near Field Communication (e.g., NFC contactless communication), radio frequency communication (e.g., RF communication such as short-wavelength radio waves, e.g., UHF waves), and/or any other desired communication technique.

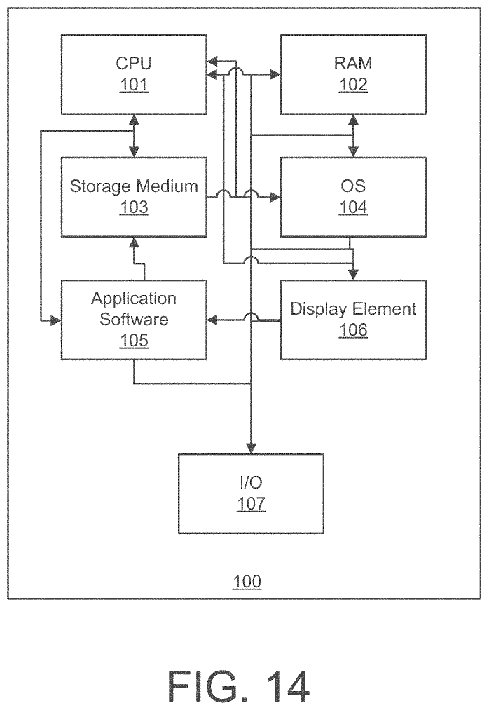

System 300 may include one or more modules that may be partially or substantially entirely integrated with one or more components of system 300 such as, for example, controller 480, one or more network components 490, and/or any other suitable component of system 300. The one or more modules may be software modules as described for example below regarding FIG. 14. For example, the one or more modules may include computer-executable code stored in non-volatile memory. The one or more modules may also operate using a processor (e.g., as described for example herein). The one or more modules may store data and/or be used to control some or all of the disclosed processes described herein.

Controller 480 may control an operation of system 300. Some or substantially all components of controller 480 may be disposed in cavity 390. Also, for example, components of controller 480 may be disposed in cavity 390, disposed at other location of closure 310, and/or integrated into one or more network components 490. Controller 480 may be any suitable computing device for controlling an operation of components of system 300. Controller 480 may, for example, include components similar to the components described below regarding FIG. 14. Controller 480 may include for example a processor (e.g., micro-processing logic control device) or board components. Also, for example, controller 480 may include input/output arrangements that allow it to be connected (e.g., via wireless, Wi-Fi, Bluetooth, or any other suitable communication technique) to other components of system 300. Controller 480 may communicate with components of system 300 via direct (e.g., wire communication), wireless communication, Wi-Fi, Bluetooth, network communication, internet, and/or any other suitable technique. Communication path element 465 may be connected to controller 480. Controller 480 may transfer data to and from sensor 455 via communication path element 465. In at least some embodiments, controller 480 may include a data-logger that may store and process information generated by sensor 455 over time. Controller 480 may also transfer and receive data (e.g., including sensed data) to and from one or more network components 490 via the disclosed communication techniques described for example herein.

Controller 480 may include an orientation device 495. Orientation device 495 may be an integral component of controller 480, a separate component disposed in cavity 390, or disposed at any other suitable location of closing element 310 or container 305. For example, orientation device 495 may be disposed at or in any suitable surface or wall member of closing element 310 or container 305. Orientation device 495 may communicate with controller 480 and/or one or more network components 490 by any suitable technique such as, for example, the communication techniques described herein. Orientation device 495 may be any suitable device for detecting a physical orientation of container 305. In at least some embodiments, orientation device 495 may be an accelerometer or a gyroscope. Orientation device 495 may sense, record, and transmit data of an actual orientation of container 305, including data of an amount of time that container 305 is subjected to each recorded orientation (e.g., when and an amount of time that container 305 is in an upright position and a dynamic position such as tipped over, at an angle, or upside down).

Controller 480, one or more network components 490, and/or the disclosed module may process and make calculations regarding a thermal performance based on sensed data collected and transferred from sensor 455 and/or orientation device 495. In at least some embodiments, the sensed data may be used to calculate (e.g., reliably calculate) an estimated performance of container 305 based on comparing disclosed orientation data to predetermined thresholds (e.g., qualification data of a given type of container 305 under various orientations and time durations). In at least some embodiments, orientation device 495 may be built into container 305 and/or closing element 310 and may record and report an orientation and duration of orientation of container 305 in real-time or near real-time to the disclosed module (e.g., a cloud-based application). Orientation device 495, controller 480, one or more network components 490, sensor 455, and/or the disclosed module may provide an alert to a user (e.g., to a user device) of system 300 when an orientation (e.g., or a temperature) of container 305 exceeds a predetermined threshold (e.g., exceeds a threshold). Orientation device 495 (e.g., and/or sensor 455), in conjunction with the disclosed cloud-based application, may similarly provide a user with data or information relating to the thermal performance of container 305. Also, based on predetermined (e.g., and/or sensed) data of the NVR of container 305 having closing element 310 in the installed position may allow a user to determine an expected performance of container 305 based on the sensed orientation and time duration data determined based on collection and/or processing of data of sensor 455 and/or orientation device 495.

Power source 485 may be any suitable power source for providing power to components of system 300 such as, for example, sensor 455 and orientation device 495. Power source 485 may be any suitable electrical power source, and/or any suitable rechargeable or non-rechargeable power source. For example, power source 485 may be a nickel-metal hydride battery, a lithium-ion battery, an ultracapacitor battery, a lead-acid battery, and/or a nickel cadmium battery.

The disclosed apparatus, system, and method may be used in any suitable application involving transporting materials having relatively low or relatively extremely low boiling points. For example, the disclosed apparatus, system, and method may be used in any suitable application for storing and/or transporting cryogenic materials such as cryogenic fluids. The disclosed apparatus, system, and method may also be used in any suitable application for transporting materials in which little or substantially no heat transfer to or from the transported material is desired.

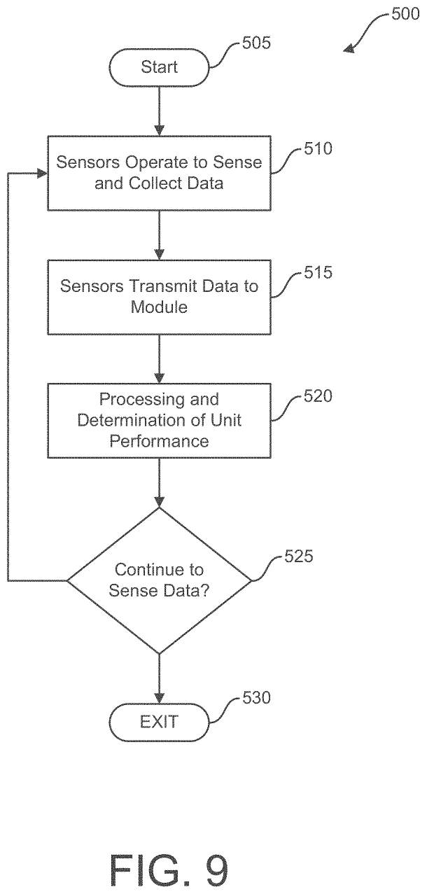

An operation of the disclosed apparatus, system, and method will now be described. For example, FIG. 9 illustrates an process 500 of system 300. Process 500 begins at step 505. At step 510, sensor 455 and orientation device 495 may operate for example as described above to sense data. Sensor 455 may sense a temperature of cavity 325 (e.g., of material 320 disposed in cavity 325). Orientation device 495 may sense an actual orientation of container 305, including measuring an amount of time that container 305 is subjected to each recorded orientation (e.g., when and an amount of time in which container 305 is in an upright position and a dynamic position such as tipped over, at an angle, or upside down). Orientation device 495 may thereby sense information indicating an orientation of container 305 over any desired period of time.

At step 515, sensor 455 and orientation device 495 may transmit data in real-time or near real-time for example by any suitable disclosed technique to the disclosed module (e.g., to controller 480 and/or network component 490).Data transmission can occur automatically as one or more networks over which to transmit data are available. During transmission of data, sensor 455 and orientation device 495 can continue to operate to sense data. Data can also be retained with the closing element 310 after transmission.

At step 520, the disclosed module (e.g., controller 480 and/or network component 490) may process and make calculations regarding a thermal performance based on sensed data collected and transferred from sensor 455 and/or orientation device 495. Continuous (e.g., or desired intervals of) data of the temperature of cavity 325 (e.g., of material 320) over time and the varying orientation of container 305 over time may be transferred, processed, and used in the disclosed calculations. In at least some embodiments, the sensed data may be used to calculate an estimated thermal performance of container 305 based on comparing disclosed orientation data to predetermined thresholds for example as described above. The disclosed module (e.g., controller 480 and/or network component 490), based on the sensed data and predetermined (e.g., and/or sensed) data of the NVR of container 305 having closure 310 in the installed position, may determine an expected performance of container 305. Any desired calculations may be made using the collected data.

At step 525, the disclosed module (e.g., controller 480 and/or network component 490) may determine whether or not to continue to sense data based on any suitable criteria such as, for example, a predetermined time, temperature, or other threshold, an algorithm, user input or commands (e.g., from an disclosed user device of one or more network components 490), an operation of controller 480 and/or network component 490, and/or any other suitable criteria. In an embodiment, data is sensed and collected periodically as determined by a user. If sensing is to continue, process 500 proceeds to step 510, and steps 510 through 525 may be repeated for as long as desired and for as many iterations as desired. If sensing is not to continue, process 500 may end at step 530.

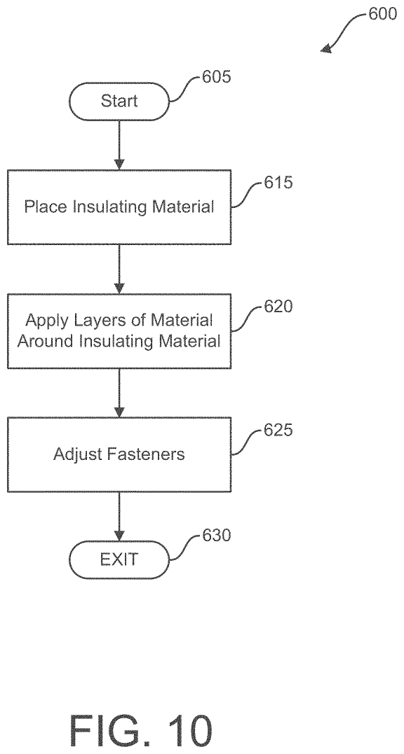

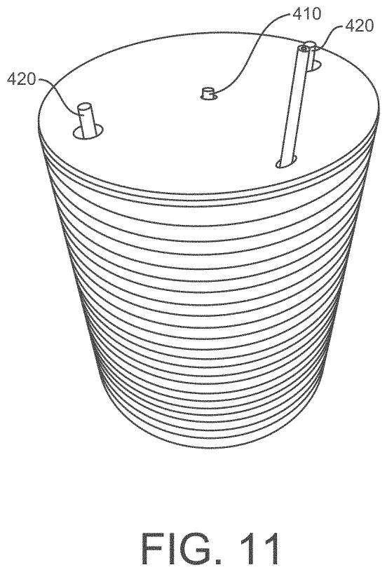

FIG. 10 illustrates a process 600 for manufacturing the disclosed apparatus, according to an embodiment Process 600 begins at step 605. Insulating material 348 can be placed at step 615. For example, either a single mass of insulating material 348 can be placed or a plurality of layers of insulating material 348 can be stacked. FIG. 11 illustrates a stack of layers. Before or after positioning insulating material 348, suitable apertures or holes (as discussed above) can be cut into insulating material 348 for receiving one or more of vent member 410, members 420, communication path element 465, and/or sensor 455. One or more members 420 (e.g., two members 420) each including one or more fastening components 425 can be positioned through insulating material 348. In some embodiments, vent member 410 or a member for forming fluid passage 405 can also be disposed through insulating material 348. Communication path element 465 and/or a member 705 for forming hole 470 to receive communication path element 465 can also be disposed through insulating material 348.

Blanket layers of insulating material 348 can be beneficial to dispose communication path element 465 through insulating material 348. In some embodiments, communication path element 465 can be moved through hole 470 in layers of insulating material 348 by attaching communication path element 465 to sensor 455, if communication path element 465 is not already attached to sensor 455, and then pushing/pulling sensor 455 through one layer, or one set of layers, of insulating material 348 at a time, until communication path element 465 extends through all the layers of insulating material 348. As discussed above, insulating material 348, such as aerogel material, can be elastically deformable, such that hole 470 can be sized smaller than communication path element 465, hole 470 can expand around sensor 455 as sensor 455 moved through hole 470, and hole 470 can contract around communication path element 465 after sensor 455 exits hole 470.

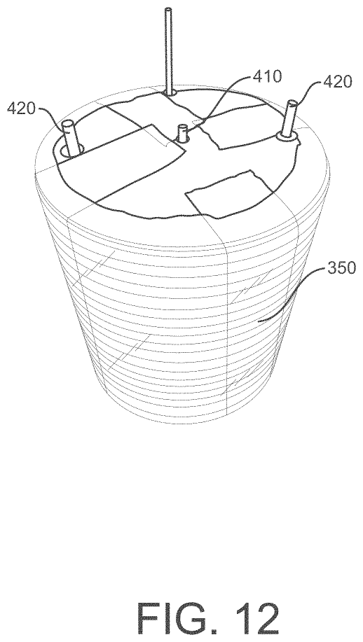

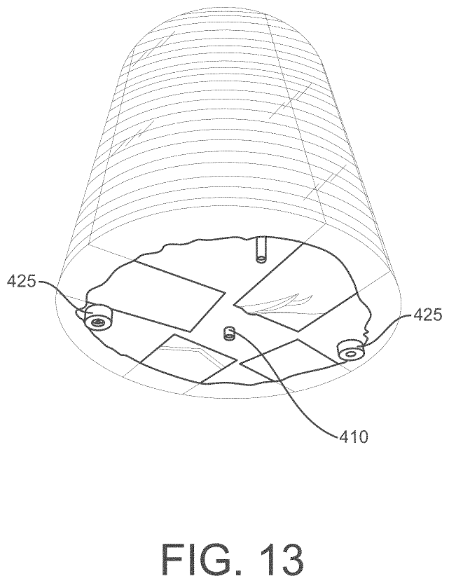

Referring again to FIG. 10, the layers 350, 355, 360 of material can be applied to (e.g., wrapped around) insulating material 348 at step 620. For example as illustrated in FIG. 12, first layer 350 can be applied to insulating material 348 for example as described above. Second layer 355 can also be applied to first layer 350, and third layer 360 can be applied to second layer 355, for example as described above. Returning to FIG. 10, fastening components 425 can be adjusted at step 625 for example as described above and as illustrated in FIG. 13. Process 600 ends at step 630.

An illustrative representation of a computing device appropriate for use with embodiments of the system of the present disclosure is shown in FIG. 14. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 15, which is discussed herein-below.

According to an embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 15, a schematic overview of a system in accordance with an embodiment of the present disclosure is shown. The system is comprised of one or more application servers 203 for electronically storing information used by the system.

Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an embodiment, as shown in FIG. 15, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component.

Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The disclosed system may for example utilize collected to prepare and submit datasets and variables to cloud computing clusters and/or other analytical tools (e.g., predictive analytical tools) which may analyze such data using artificial intelligence neural networks. The disclosed system may for example include cloud computing clusters performing predictive analysis. For example, the disclosed system may utilize neural network-based artificial intelligence to predictively assess risk. For example, the neural network may include a plurality of input nodes that may be interconnected and/or networked with a plurality of additional and/or other processing nodes to determine a predicted result (e.g., a location as described for example herein).

For example, artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also, for example, artificial intelligence processes may include processing for training a machine learning model to make predictions based on data collected by the disclosed sensors.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation Kotlin, Swift, C#, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

What is claimed is:

1. A closing element for selectively blocking an opening of a cryogenic storage container, comprising:
a head assembly and a bottom member;
at least one layer of insulating material disposed between the head assembly and the bottom member;
at least one hole extending through the at least one layer of insulating material; and
at least one member disposed in the at least one hole and extending through the insulating material;
wherein a diameter of the at least one hole is substantially equal to a diameter of the at least one member.

2. The closing element of claim 1, wherein the at least one layer of insulating material includes a plurality of layers of insulating material, and wherein the closing element further includes at least one metal foil material disposed between the plurality of layers of insulating material.

3. The closing element of claim 1, wherein the at least one layer of insulating material includes a blanket of aerogel material.

4. The closing element of claim 3, wherein the at least one layer of insulating material includes a first blanket of aerogel material and a second blanket of aerogel material, and wherein the closing element further comprises a sensor and a communication path element, the communication path element extending through the first blanket material and the second blanket material to the sensor, the first blanket material and the second blanket compressing around the communication path element.

5. The closing element of claim 1, wherein the at least one member is formed from phenolic material, and a first end portion of the at least one member is attached to the head assembly and a second end portion of the at least one member is attached to the bottom member.

6. The closing element of claim 1, further comprising at least one fastening component including an insert that receives an end portion of the at least one member, the at least one fastening component forming a flange that applies compression from at least one of the head assembly and the bottom member to the at least one layer of insulating material.

7. The closing element of claim 6, wherein the fastening component is formed from Garolite material, the insert is a threaded insert, and the end portion is threaded.

8. The closing element of claim 1, further comprising an outer layer including laminated materials, the outer layer covering an exterior surface of the at least one layer of insulating material, the laminated materials including a heat shrink tubing or a linear low density polyethylene film.

9. The closing element of claim 1, further comprising an outer layer including laminated materials, the outer layer covering an exterior surface of the at least one layer of insulating material, the laminated materials including a non-woven high-density polyethylene fiber material in rolled form.

10. The closing element of claim 1, further comprising an outer layer including laminated materials that covers an exterior surface of the at least one layer of insulating material, the laminated materials including a microcellular foam material.

11. The closing element of claim 1, further comprising an outer layer including laminated materials, the outer layer covering an exterior surface of the at least one layer of insulating material, the laminated materials including a polyester fleece material.

12. The closing element of claim 1, further comprising:
a linear low-density polyethylene film wrapped around an exterior surface of the at least one layer of insulating material;
a non-woven high-density polyethylene fiber material in rolled form wrapped around the linear low-density polyethylene film; and
a fleece material on the non-woven high-density polyethylene fiber material.

13. The closing element of claim 12, further comprising a microcellular foam material on the fleece material.

14. The closing element of claim 1, further comprising a vent member disposed in the at least one layer of insulating material, the vent member sized to transfer fluid coolant from a cryogenic cavity of the cryogenic storage container to maintain pressure of 7.25 PSI or less in the cavity.

15. The closing element of claim 1, further comprising a sensor fixedly disposed in a pocket of the bottom member, the bottom member configured to face a cryogenic cavity of the cryogenic storage container when the closing element is installed to close an opening of the cryogenic storage container.

16. A method of manufacturing a closing element to block an opening of a cryogenic storage container, comprising:
providing at least one layer of insulating material;
providing at least one hole extending through at least one layer of the insulating material;
providing at least one member in the at least one hole;
inserting an end portion of the at least one member in a fastening component; and
compressing the at least one layer of insulating material by moving the fastening component relative to the at least one member.

17. The method of claim 14, further comprising disposing an outer layer on an exterior surface of the at least one layer of insulating material, the outer layer including at least one from the group consisting of: a linear low density polyethylene film; a non-woven high-density polyethylene fiber material in rolled form; a fleece material, and microcellular foam.

18. The method of claim 16, wherein providing at least one layer of insulating material includes providing a first one or more blanket layers of insulating material and providing a second one or more blanket layers of insulating material, wherein the method further comprises:
providing a sensor with a first outer dimension;
cutting a first sensor hole through the first one or more blanket layers of insulating material, the first sensor hole having a first diameter smaller than the first outer dimension of the sensor;
cutting a second sensor hole through the one or more blanket layers of insulating material, the second sensor hole having a second diameter smaller than the first outer dimension of the sensor;
moving the sensor through the first sensor hole in a direction substantially perpendicular to a plane containing the first outer dimension; and
separately from moving the sensor through the first sensor hole, moving the sensor through the second sensor hole in a direction substantially perpendicular to the plane containing the first outer dimension.

19. A cryogenic storage container, comprising:
a housing including a cavity and a neck opening;
a closing element that is configured to be selectively inserted in the neck opening, the closing element including:
a head assembly and a bottom member;
at least one layer of insulating material disposed between the head assembly and the bottom member;
at least one hole extending through the at least one layer of insulating material; and
at least one member disposed in the at least one hole and extending through the at least one layer of insulating material;
wherein a diameter of the at least one hole is substantially equal to a diameter of the at least one member.

20. The cryogenic storage container of claim 19, wherein the closing element further comprises:
a linear low-density polyethylene film wrapped around an exterior surface of the at least one layer of insulating material;
a non-woven high-density polyethylene fiber material wrapped around the linear low-density polyethylene film; and
a polyester fleece material disposed on the non-woven high-density polyethylene fiber material.

21. The cryogenic storage container of claim 20, wherein the closing element further comprises a microcellular foam material applied on the fleece.

22. The cryogenic storage container of claim 19, wherein the closing element further comprises a linear low density polyethylene film wrapped around the at least one layer of insulating material.

23. The cryogenic storage container of claim 19, wherein the closing element further comprises a non-woven high-density polyethylene fiber material wrapped around the at least one layer of insulating material.

24. The cryogenic storage container of claim 19, wherein the closing element further comprises a polyester fleece material wrapped around the at least one layer of insulating material.

25. The cryogenic storage container of claim 19, wherein the closing element further comprises a microcellular foam material wrapped around the at least one layer of insulating material.

26. The cryogenic storage container of claim 19, further comprising a temperature sensor that is fixedly disposed in a pocket of the bottom member, the temperature sensor including a sensor tip that is exposed to the cryogenic cavity when the temperature sensor is fixedly disposed in the pocket.
